(19) United States
(12) Patent Application Publication
(10) Pub. No.: US 2003/0198806 A1
(43) Pub. Date: Oct. 23, 2003

(54) Method for covering an elongated element, especially a loom of cables with an adhesive strip

(76) Inventors: Matthias Von Samson-Himmelstjerna, Henstedt-Ulzburg (DE); Esther Musahl, Offenburg (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/363,276

(22) PCT Filed: Aug. 21, 2001
(86) PCT No.: PCT/EP01/09597

(30) Foreign Application Priority Data
Aug. 31, 2000 (DE) 100 42 732.4

(51) Int. Cl. B32B 7/12

(52) U.S. Cl. 428/343; 428/375

(57) ABSTRACT

A method of wrapping elongate product, especially cable harnesses, with an adhesive tape which is passed in a helical movement around said elongate product, the adhesive composition being applied, on at least one side of the backing material of the adhesive tape, lengthwise in the form of a strip whose width is lower than that of the backing material of the adhesive tape.

The invention relates to a method of wrapping elongate product, especially cable harnesses, with an adhesive tape.

The use of adhesive tapes with a nonwoven web backing for bandaging cable harnesses is known. Accordingly, DE-U 94 01 037 describes an adhesive tape having a tapelike textile backing comprising a stitchbonded web formed in turn from a large number of stitches which have been sewn in and which run parallel to one another. On the basis of its special design, the adhesive tape described exhibits soundproofing properties in the course of its use for cable harness bandaging.

Besides the stitchbonded nonwoven mentioned in the cited document, there are further backings used in adhesive tapes for cable harness bandaging.

DE 44 42 092 describes such an adhesive tape, based on stitchbonded webs, which is coated on the reverse of the backing. DE 44 42 093 is based on the use of a web as backing for an adhesive tape, said web being a cross-laid fiber web which is reinforced by the formation of loops from the fibers of the web, i.e., a web known to the person skilled in the art by the name Malifleece. DE 44 42 507 discloses an adhesive tape for cable bandaging, but bases it on so-called Kunit or Multiknit webs.

DE 195 23 494 C1 discloses the use of an adhesive tape having a backing comprising web product for bandaging cable harnesses, said tape being coated on one side with an adhesive. The web employed in accordance with the invention is a polypropylene spunbonded web which is thermally consolidated and embossed with the aid of a calender, the embossing roll having an embossing area of from 10% to 30%, preferably 19%.

DE 298 04 431 U1 likewise discloses the use of an adhesive tape having a backing comprising web product for the bandaging of cable harnesses, the proposed spunbonded Web being of polyester.

DE 298 19 014 U1 discloses adhesive tapes based on a web which is consolidated with jets of air and/or water.

DE 199 23 399 discloses an adhesive tape having a tapelike backing of nonwoven web product, which is coated on at least one side with an adhesive, the web being a staple fiber web which is consolidated mechanically or is wet-laid. Between 2% and 50% of the fibers of the web are fusible fibers, specifically homopolymer, copolymer or bicomponent fibers having a relatively low softening or melting point.

It is mentioned by way of example that the fusible fibers of the web are of polypropylene, polyethylene, polyamide, polyester or copolymers.

Another adhesive tape having a tapelike backing of web product is disclosed in DE 199 37 446. The adhesive tape is coated on at least one side with an adhesive, the web being a staple fiber web which is consolidated mechanically or is Wet-laid. Here, the further consolidation of the staple fiber web is accomplished by addition of binders, such as powders, films, meshes or binding fibers, for example. The binders may have been dissolved in water or organic solvent and/or may be present in dispersion form.

The binders are preferably employed as binder dispersions such as elastomers or such as thermosets in the form of phenolic or melamine resin dispersions, as dispersions of natural or synthetic rubbers, or as dispersions of thermoplastics such as acrylates, vinyl acetates, polyurethanes, styrene-butadiene systems, PVC, and copolymers thereof.

WO 99/24518 A1 describes an adhesive tape where the backing product is a web which acquires its adhesive tape suitability only through the specific selection of fibers or filaments having a linear density of more than 15 denier and also through a film layer which is extruded on additionally.

DE 197 32 958 A1 discloses an adhesive tape for wrapping elongate product, such as cable harnesses or plastic sections, which has a tapelike backing bounded by two lateral edges and provided on at least one side with a self-adhesive layer of a pressure-sensitive adhesive (PSA). The chemical composition of the PSA is such that, under gentle applied pressure on two adhesive layers lying one above the other, the interfaces are parted and the adhesive films coalesce completely to form a homogeneous PSA mass.

The invention depicted here also embraces a method of wrapping the elongate product. According to that method, the elongate product is positioned lengthways, in the region of a section of the adhesive tape, on a side of a tapelike backing of the adhesive tape that is provided with a self-adhesive layer, and then the adhesive tape is bonded in such a way that at least two adhesive regions of the tapelike backing are stuck to one another on the side provided with the adhesive layer in such a way that interfaces of the adhesive layer part to form a homogeneous mass.

The result is therefore a pennant which protrudes from the wrapped product and which, especially under the restricted space conditions in automobile construction, is highly undesirable and harbors the potential risk that, when the cable harness is drawn through restricted apertures or passages, in the bodywork, for example, the wrapping will remain hanging and tear off, or at least the sheath will be damaged. This is to be avoided.

EP 1 000 992 A1 describes a perforated cotton web having a polyethylene coating, from 10 to 45 μm in thickness, and an additional release coating.

It is an object of the present invention to provide a method which permits the particularly simple, inexpensive, and rapid wrapping of elongate product such that the disadvantages of the prior art do not occur, or at least not to the same extent.

This object is achieved by a method as set out in the main claim. The subclaims relate to advantageous developments of the method and to a cable harness wrapped according to the method of the invention.

The invention accordingly provides methods of wrapping elongate product, especially cable harnesses, with an adhesive tape which is passed in a helical movement around the elongate product. On at least one side of the backing product of the adhesive tape, the adhesive composition is applied lengthways in the form of a strip whose width is lower than that of the backing product of the adhesive tape. In a first advantageous embodiment of the method, the adhesive tape is passed around the product in such a way that the adhesive composition is on the inside relative to the center axis of the product.

In a further advantageous embodiment of the method, the adhesive tape is passed around the product in such a way that the adhesive tape is on the outside relative to the center axis of the product.

In another advantageous embodiment, the adhesive tape is coated with adhesive composition on both sides of the backing, with coating taking place in each case on only part of the backing. The coatings on the two different sides are offset; in other words, on one side of the backing the coating is located at the right-hand edge and on the opposite side the adhesive composition is located on the left-hand edge. When a cable harness is wrapped, one adhesive area lies on the outside, relative to the center axis of the product, while the other adhesive area lies on the inside. When the next ply is wound around, then, the outer adhesive area of the bottom adhesive tape and the inner adhesive area of the top adhesive tape stick wholly or partly to one another.

In one advantageous embodiment, the coated strip has a width of from 10 to 80% of the width of the backing material, depending on the application. Particular preference is given to the use of strips with a coating of from 20 to 50% of the width of the backing material.

Depending on the application in hand, it is also possible for two or more parallel strips of the adhesive to have been coated onto the backing material.

By means of the three inventive ways of wrapping the product by means of an adhesive tape, it is possible to ensure that the strip of adhesive composition sticks to a large extent completely to the adhesive tape itself. In the variant with adhesive tape on the inside, product and adhesive composition stick at the beginning of winding, and this fixing prevents slippage of the wind during winding. In the variant with adhesive composition on the outside, there is neither sticking to the product nor, on the outside, an exposed section of adhesive composition on which dirt might accumulate.

Where less than 100% of the adhesive composition is covered, it is possible with adhesive composition situated on the inside to bond some of the adhesive composition to the cable, so that the cable harness is secured against slippage and is nevertheless flexible.

With adhesive composition situated on the outside, it is possible in this way to leave some of the adhesive composition outwardly showing, not covered by the next adhesive tape ply, in order to allow for subsequent fixing—to bodywork panels, for example.

As backing material for the adhesive tape it is possible to use all known textile backings such as wovens, knits or nonwoven webs; the term “web” embraces at least textile sheetlike structures in accordance with EN 29092 (1988) and also stitchbonded nonwovens and similar systems.

It is likewise possible to use spacer fabrics, including wovens and knits, with lamination. Spacer fabrics of this kind are disclosed in EP 0 071 212 B1. Spacer fabrics are matlike layer structures comprising a cover layer of a fiber or filament fleece, an underlayer and individual retaining fibers or bundles of such fibers between these layers, said fibers being distributed over the area of the layer structure, being needled through the particle layer, and joining the cover layer and the underlayer to one another. As an additional though not mandatory feature, the retaining fibers in accordance with EP 0 071 212 B1 comprise inert mineral particles, such as sand, gravel or the like, for example.

The holding fibers needled through the particle layer hold the cover layer and the backing layer at a distance from one another and are joined to the cover layer and the backing layer.

Spacer wovens or spacer knits are described, inter alia, in two articles, namely

an article from the journal kettenwirk-praxis 3/93, pages 59 to 63, “Raschelgewirkte Abstandsgewirke” [Raschel-knitted spacer knits] and

an article from the journal kettenwirk-praxis 1/94, pages 73 to 76, “Raschelgewirkte Abstandsgewirke”,

the content of said articles being included here by reference and being part of this disclosure and invention.

Suitable nonwovens include, in particular, consolidated staple fiber webs, but also filament webs, meltblown webs, and spunbonded webs, which generally require additional consolidation. Known consolidation methods for webs are mechanical, thermal, and chemical consolidation. Whereas with mechanical consolidations the fibers can be held together purely mechanically by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to the fiber nodal points, so that a stable, three-dimensional network is formed while retaining the loose open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Meyer, formerly Malimo, and can be obtained, inter alia, from the companies Naue Fasertechnik and Techtex GmbH. A Malifleece is characterized in that a cross-laid web is consolidated by the formation of loops from fibers of the web.

The backing used may also be a web of the Kunit or Multiknit type. A Kunit web is characterized in that it originates from the processing of a longitudinally oriented fiber web to form a sheetlike structure which has the heads and legs of loops on one side and, on the other, loop feet or pile fiber folds, but possesses neither threads nor prefabricated sheetlike structures. A web of this kind has been produced, inter alia, for many years, for example on stitchbonding machines of the “Kunitvlies” type from the company Karl Mayer. A further characterizing feature of this web is that, as a longitudinal-fiber web, it is able to absorb high tensile forces in the longitudinal direction. The characteristic feature of a Multiknit web relative to the Kunit is that the web is consolidated on both the top and bottom sides by virtue of the double-sided needle punching.

Finally, stitchbonded webs are also suitable as an intermediate forming an adhesive tape of the invention. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

Also particularly advantageous is a staple fiber web which is mechanically preconsolidated in the first step or is a wet-laid web laid hydrodynamically, in which between 2% and 50% of the web fibers are fusible fibers, in particular between 5% and 40% of the fibers of the web.

A web of this kind is characterized in that the fibers are laid wet or, for example, a staple fiber web is preconsolidated by the formation of loops from fibers of the web or by needling, stitching or air-gap or water-jet treatment.

In a second step, thermofixing takes place, with the strength of the web being increased again by the (partial) melting of the fusible fibers.

The web backing may also be consolidated without binders, by means for example of hot embossing with structured rollers, with properties such as strength, thickness, density, flexibility, and the like being controllable via the pressure, temperature, residence time, and embossing geometry.

For the inventive use of nonwovens, the adhesive consolidation of mechanically preconsolidated or wet-laid webs is of particular interest, it being possible for said consolidation to take place by way of the addition of binder in solid, liquid, foamed or pastelike form. A great diversity of theoretical embodiments is possible: for example, solid binders as powders for trickling in; as a sheet or as a mesh, or in the form of binding fibers. Liquid binders may be applied as solutions in water or organic solvent or as a dispersion. For adhesive consolidation, binder dispersions are predominantly chosen: thermosets in the form of phenolic or melamine resin dispersions, elastomers as dispersions of natural or synthetic rubbers, or, usually, dispersions of thermoplastics such as acrylates, vinyl acetates, polyurethanes, styrene-butadiene systems, PVC, and the like, and also copolymers thereof. Normally, the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” (Georg Thieme Verlag, Stuttgart, 1982) or “Textiltechnik-Vliesstofferzeugung” (Arbeitgeberkreis Gesamttextil, Eschborn, 1996).

For mechanically preconsolidated webs which already possess sufficient composite strength, the single-sided spray application of a binder is appropriate for effecting specific changes in the surface properties.

Such a procedure is not only sparing in its use of binder but also greatly reduces the energy requirement for drying. Since no squeeze rolls are required and the dispersion remains predominantly in the upper region of the web material, unwanted hardening and stiffening of the web can very largely be avoided.

For sufficient adhesive consolidation of the web backing, the addition of binder in the order of magnitude of from 1% to 50%, in particular from 3% to 20%, based on the weight of fiber web, is generally required.

The binder may be added as early as during the manufacture of the web, in the course of mechanical preconsolidation, or else in a separate process step, which may be carried out in-line or off-line. Following the addition of the binder it is necessary temporarily to generate a condition in which the binder becomes adhesive and adhesively connects the fibers—this may be achieved during the drying, for example, of dispersions, or else by heating, with further possibilities for variation existing by way of areal or partial application of pressure. The binder may be activated in known drying tunnels, or else, given an appropriate selection of binder, by means of infrared radiation, UV radiation, ultrasound, high-frequency radiation or the like. For the subsequent end use it is sensible, although not absolutely necessary, for the binder to have lost its tack following the end of the web production process. It is advantageous that, as a result of the thermal treatment, volatile components such as fiber assistants are removed, giving a web having favorable fogging values so that when a low-fogging adhesive composition is used it is possible to produce an adhesive tape having particularly advantageous fogging values.

A further, special form of adhesive consolidation consists in activating the binder by incipient dissolution or swelling. In this case it is also possible in principle for the fibers themselves, or admixed special fibers, to take over the function of the binder. Since, however, such solvents are objectionable on environmental grounds, and/or are problematic in their handling, for the majority of polymeric fibers, this process is not often employed.

Starting materials envisaged for the textile backing include, in particular, polyester, polypropylene, viscose or cotton fibers. The present invention is, however, not restricted to said materials; rather it is possible to use a large number of other fibers to produce the web, this being evident to the skilled worker without any need for inventive activity.

However, a backing material of paper, of a laminate, of a film (for example PP, PE, PET, PA), of foam, or of a foamed film is also suitable for wrapping the elongate product.

Low flammability in the adhesive tapes may be achieved by adding flame retardants to the (web) backing and/or to the adhesive composition. These retardants may be organobromine compounds, together where appropriate with synergists such as antimony trioxide; however, with a view to the absence of halogens from the adhesive tape, preference will be given to using red phosphorus, organophosphorus compounds, mineral compounds or intumescent compounds such as ammonium polyphosphate, alone or in conjunction with synergists.

To produce adhesive tapes, the backing material is coated, on one side in particular, in the lengthwise direction with a strip of adhesive composition, the coating technologies and the adhesive compositions being in accordance with the prior art.

It is also possible to laminate a coated adhesive tape onto an uncoated backing.

In the case of the double-sidedly adhesive tape, it is also possible to laminate two coated adhesive tapes onto one another in such a way that adhesive composition bonds to adhesive composition. In this case, one adhesive-composition side points upward, the other downward.

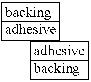

The above figure shows how a particularly advantageous adhesive tape is produced, namely by laminating the adhesive-composition sides of two single-sidedly coated adhesive tapes, coated in particular over their full area, onto one another with an offset. The offset is preferably less than 50%, with particular preference between 20 and 30%.

As adhesive compositions it is possible in principle to choose different polymer systems, with natural or synthetic rubber and also acrylate systems having proven particularly advantageous; silicone adhesive compositions and other known self-adhesive compositions may likewise be employed for such applications provided their adhesion properties, temperature stabilities, compatibilities with the cable insulating materials, etc. are in accordance with the requirements.

Particularly advantageous for the concept of the invention is a fogging-free self-adhesive tape comprising a fogging-free backing on at least one side of which there is applied a fogging-free, pressure-sensitive adhesive composition.

A suitable adhesive composition is one based on acrylate hot melt, having a K value of at least 20, in particular more than 30 (measured in each case in 1% strength by weight solution in toluene at 25° C.), obtainable by concentrating a solution of such a composition to give a system which can be processed as a hot melt.

Concentrating may take place in appropriately equipped vessels or extruders; particularly in the case of accompanying devolatilization, a devolatilizing extruder is preferred.

An adhesive composition of this kind is set out in the German patent application DE 43 13 008 C2. In an intermediate step, the solvent is removed completely from the acrylate compositions prepared in this way.

The K value is determined in particular in analogy to DIN 53 726.

In addition, further volatile constituents are removed. After coating from the melt, these compositions contain only small fractions of volatile constituents. Accordingly, it is possible to adopt all of the monomers/formulations claimed in the above-cited patent. A further advantage of the compositions described in the patent is that they have a high K value and thus a high molecular weight. The skilled worker is aware that systems with higher molecular weights may be crosslinked more efficiently. Accordingly, there is a corresponding reduction in the fraction of volatile constituents.

The solution of the composition may contain from 5 to 80% by weight, in particular from 30 to 70% by weight, of solvent.

It is preferred to use commercially customary solvents, especially low-boiling hydrocarbons, ketones, alcohols and/or esters.

Preference is further given to using single-screw, twin-screw or multiscrew extruders having one or, in particular, two or more devolatilizing units.

The adhesive composition based on acrylate hot melt may contain copolymerized benzoin derivatives, such as benzoin acrylate or benzoin methacrylate, for example, acrylates or methacrylates. Benzoin derivatives of this kind are described in EP 0 578 151 A.

The adhesive composition based on acrylate hot melt may be UV-crosslinked. Other types of crosslinking, however, are also possible, an example being electron beam crosslinking.

In one particularly preferred embodiment, self-adhesive compositions used comprise copolymers of (meth)acrylic acid and esters thereof having from 1 to 25 carbon atoms, maleic, fumaric and/or itaconic acid and/or esters thereof, substituted (meth)acrylamides, maleic anhydride, and other vinyl compounds, such as vinyl esters, especially vinyl acetate, vinyl alcohols and/or vinyl ethers.

The residual solvent content should be below 1% by weight.

Owing in particular to the low thicknesses of the backing material, suitable coating techniques are those which place the adhesive composition onto the backing virtually without pressure and, where appropriate, without contact, or else indirect coating techniques.

This not only prevents adhesive composition being pressed into the backing—particularly the textile backing—and so being uselessly squandered for the subsequent bonding requirements, but also ensures that the open, textile structure, which provides for good breathing properties, suffers only minimal, if any, alteration.

Examples that may be mentioned here include not only the transferring of the adhesive composition from silicone release paper but also transfer by way of other temporary transfer media such as belts and the like and also pressureless adhesive coating by means of extrusion dies and the like, in which a fabricated film of adhesive composition is placed onto the backing. Any improvement that may be necessary in the anchoring of the adhesive composition on the backing may be achieved, following coating of the adhesive, by applying temperature and/or pressure, in laminating stations, for example.

One possible indirect process for producing a flat, flexible backing coated with a porous film of adhesive is disclosed in DE 40 32 776 A1.

According to this process,

a) a flowable adhesive composition is applied to an interim backing which has the following properties:

under a light microscope or electron microscope it can be seen to have a corrugated, pleated, fissured or furrowed surface

the adhesive composition is readily detachable from its surface

it is substantially impermeable to air

b) the microscropic air or solvent solutions which form between the adhesive composition and the interim backing after the latter has been coated are expanded by temperature increase until the surface of the adhesive composition bursts open, and

c) the adhesive composition is then transferred from the interim backing to the final backing.

In contradistinction to the porous adhesive coating which is the aim of DE 40 32 776 A1, a very largely homogeneous, smooth, air-free and imperveous adhesive coating is of advantage for the subject matter of this invention. If, however, a smooth and homogeneous surface of the interim backing is chosen instead of the textured surface described above, these requirements can be met.

The base for the interim backing may be chosen from all common materials for such purposes. Particularly advantageous are woven belts of glass fiber, polyester, polyamide or Nomex®, a fiber material from DuPont. However, rubber cloths, polymer belts, and the like have also been found favorable. If fabric belts are chosen, it is advantageous to use those which have already been provided with a substantially unstructured surface coating of plastic. This latter coating promotes the adhesion and uniformity of the actual surface coating on the base. The surface coating itself ensures the desired easy transfer of the adhesive composition from the interim backing to the final backing. Advantageously, this interim backing surface is coated with an antiadhesive layer of, for example, crosslinked silicone rubber or fluoropolymers such as Teflon®.

A coating of this kind is found to be particularly advantageous if the state achieved is, so to speak, “frozen in” by chemical or physical methods and “cold flow” of the adhesive composition into the backing is prevented by crosslinking. For example, the UV-crosslinkable acrylate hot melts as sold by BASF under the commercial designation acResin© are particularly suitable for such requirements: after coating, a three-dimensional crosslinking takes place by means of UV radiation. Depending on the type of adhesive composition chosen, however, it is also possible to employ other types of crosslinking with advantage, such as chemical crosslinking, thermally initiated, and radiation-chemical crosslinking by means of electron beams, or other known systems.

In another preferred embodiment of the invention, the adhesive coating is applied to the backing pressurelessly or indirectly in a strip at from 25 to 80 g/m², in particular from 30 to 50 g/m², and is then physically or chemically crosslinked.

Ultimately, the invention embraces an elongate product, particularly a cable harness, which is wrapped with an adhesive tape that is passed in a helical movement around the elongate product, the adhesive composition being applied, on one side of the backing material of the adhesive tape, lengthways in the form of a strip whose width is lower than that of the backing material of the adhesive tape, the wrapping having been performed such that the strip of adhesive composition is bonded substantially completely to the adhesive tape itself.

The adhesive tape of the invention may be provided in fixed lengths, such as in the form of meter product, for example, or else as continuous product on rolls. For use in the latter case, variable cutting to length by means of blades, shears or dispensers and the like is possible, or else, given an appropriate choice of the materials for the adhesive tapes, the product may be used manually without auxiliaries.

For adhesive bonding, the strips of adhesive tape employed are in particular those having a width of from 15 to 50 mm.

By virtue of the inventive wrapping of the preferred cable harness, the latter is outstandingly protected and vibration-damped.

The inventive solution also has the advantages that the cable harness in question is a clean, pennant-free cable harness which affords good surface protection and ensures high bundling power and good soundproofing.

As a result of the lower use of adhesive composition as compared with conventional spiral winding, the fogging is reduced by the fraction of adhesive composition not used; there is also an attenuation of the problems in compatibility between adhesive composition and cable wrapping, as may occur in particular in the case of PVC-free cables and adhesive compositions lacking special suitability, since in the case of the inventive spiral winding there is a minimal area of contact, if any, between adhesive composition and cable insulation.

Since the product is wrapped with little or no bonding on the product, the wrapped product beneath the cover remains flexible and readily alterable in terms of its position.

The embodiment with double-sided adhesive coating has the advantage, in addition, that as a result of the adhesion of adhesive composition to adhesive composition the bond is very strong. As a result, it is possible to minimize greatly the adhesive application rate, which brings with it advantages in respect of costs and fogging.

In the text below, the invention will be illustrated with reference to a number of figures, without wishing unnecessarily to restrict the invention thereby.

In the figures:

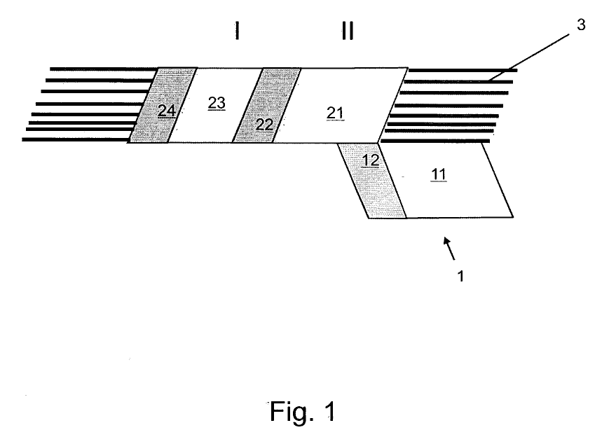

FIG. 1 shows a cable harness wrapped inventively, the adhesive tape being passed around the product such that the adhesive composition is on the inside relative to the center axis of the product, and

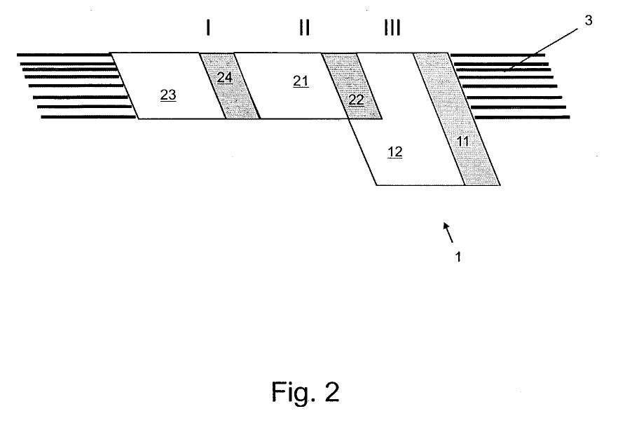

FIG. 2 shows a cable harness wrapped inventively, the adhesive tape being passed around the product such that the adhesive composition is on the outside relative to the center axis of the product.

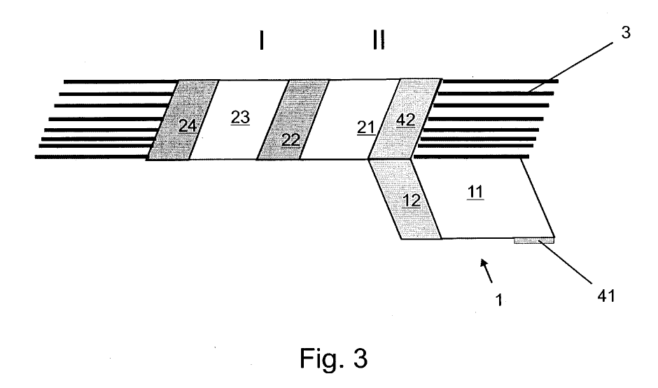

FIG. 3 shows a cable harness which is inventively wrapped, the adhesive tape having a narrow coating of an adhesive on both sides such that one adhesive composition lies against one edge of the backing material and on the other side of the backing material the adhesive composition is arranged at the opposite edge.

FIG. 1 shows a section of a cable harness tape 3 which is composed of a bundling-together of individual cables and which is wrapped inventively with an adhesive tape 1. The adhesive tape 1 is passed around the cable harness 3 in such a way that the adhesive composition 12, 22, 24 is on the inside relative to the center axis of the cable harness 3.

The section of the cable harness 3 depicted shows two winds 1 and 11 of the adhesive tape 1. Further winds would extend toward the left; these are not shown here.

The backing material 11, 21, 23 is coated on one side with an adhesive composition 12, 22, 24, application taking place in the form of a lengthways strip whose width is lower than that of the backing material 11, 21, 23 of the adhesive tape 1.

The cable harness 3 is wrapped in such a way that the strip of adhesive composition 12, 22, 24 bonds fully on the backing material 11, 21, 23 of the adhesive tape 1 itself. Bonding to the cable harness 3 is ruled out.

The adhesive tape 1 embraces (see wind I) in the width the section 24 and the section 22 and also the open backing 23 located in between. The section 22, which belongs to the wind II, therefore adheres to the section 23. (The section 24 would adhere to the backing of the next wind situated to the left.) In contrast to the exposed adhesive composition 12, the sections 22 and 24 are not visible from the outside, which is why the denser shading has been chosen to depict them.

FIG. 2 likewise shows a section of a cable harness 3 which has been inventively wrapped with an adhesive tape 1. Here, the adhesive tape 1 is passed around the cable harness 3 in such a way that the adhesive composition 12, 22, 24 is on the outside relative to the center axis of the cable harness 3. In this way the cable harness 3 does not come into contact with the adhesive composition 12, 22, 24.

Here again, the wrapping would continue toward the left. In wind I, the uncoated reverse of the adhesive tape 1 lies around the cable harness 3, with the adhesive section 24 being located on the right. Wind II is then carried out in such a way that the section 24 is covered fully by the adhesive tape 1, specifically by the section 21. In the course of the wind III, then, the section 12 is placed on in such a way as to fully cover the section 22. In this way, no adhesive composition 12, 22, 24 extends to the outside and soiling is ruled out.

FIG. 3 shows a further section of a cable harness 3 which has been wrapped inventively with an adhesive tape 1. The adhesive tape 1 has a double-sided narrow coating 12, 41 of an adhesive, applied in such a way that one adhesive 41 lies against one edge of the backing material and on the other side of the backing material the adhesive composition 12 is arranged at the opposite edge.

By the wrapping of the cable harness 3, the adhesive-composition sections 12 and 42 are joined, so producing a particularly strong bond.

What is claimed is:

1. A method of wrapping elongate product, especially cable harnesses, with an adhesive tape which is passed in a helical movement around the elongate product, the adhesive composition being applied, on at least one side of the backing material of the adhesive tape, lengthwise in the form of a strip whose width is lower than that of the backing material of the adhesive tape.

2. The method as claimed in claim 1, wherein the adhesive tape is passed around the product in such a way that the adhesive composition is on the inside relative to the center axis of the product.

3. The method as claimed in claim 1, wherein the adhesive tape is passed around the product in such a way that the adhesive composition is on the outside relative to the center axis of the product.

4. The method as claimed in any of claims 1 to 3, wherein the adhesive tape is coated on one side with a pressure-sensitive adhesive composition.

5. The method as claimed in claim 1, wherein the adhesive tape is provided on the reverse of the backing material with a further adhesive film which is offset with respect to the coating on the opposite side.

6. The method as claimed in claim 5, wherein the adhesive tape is formed by laminating the adhesive-composition sides of two single-sidedly coated adhesive tapes, coated in particular over their full area, onto one another with an offset.

7. The method as claimed in any of claims 1 to 6, wherein the cable harness is wrapped in such a way that the strip of adhesive composition bonds substantially completely to the adhesive tape itself.

8. The method as claimed in any of claims 1 to 7, wherein backing material used for the adhesive tape comprises nonwoven webs consolidated in particular by overstitching with separate threads or by interlooping or waterjets or needles.

9. The method as claimed in any of claims 1 to 8, wherein the adhesive tape has a width of from 10 to 100 mm, in particular from 15 to 50 mm.

10. An elongate product wrapped with an adhesive tape, particularly a cable harness, where the adhesive tape is passed in a helical movement around the elongate product, the adhesive composition being applied, on at least one side of the backing material of the adhesive tape, lengthwise in the form of a strip whose width is lower than that of the backing material of the adhesive tape.
